(19) United States
(12) Patent Application Publication
(10) Pub. No.: US 2003/0047648 A1
(43) Pub. Date: Mar. 13, 2003

(54) Secure cockpit system

(76) Inventors: Richard R. Batt, Menlo Park, CA (US); Katarina Jeanneau, Menlo Park, CA (US)

Correspondence Address: Richard R. Batt, 493 9th Avenue, Menlo Park, CA, 94025, US

(21) Appl. No.: 10/241,960

(22) Filed: Sep. 12, 2002

Related U.S. Application Data
(60) Provisional application No. 60/322,633, filed on Sep. 12, 2001.

(51) Int. Cl. B64D 11/00; B64D 13/00

(52) U.S. Cl. 244/118.5

(57) ABSTRACT

The present invention includes a plane comprising a passenger chamber for transporting a plurality of passengers and a cockpit separated from the passenger chamber by an impenetrable barrier. The barrier may comprise bullet-proof glass, blast-resistant polymeric materials, or other high strength (preferably lightweight) materials. The cockpit may also comprise an exit or emergency hatch to the outside of the plane. Pressure relief panels, sensors, scanners and weapon devices may be incorporated into the plane to secure the cockpit. A method of transporting at least one passenger through the air on a plane flown by at least one pilot comprises impassably separating the at least one pilot from the at least one passenger.

### CROSS-REFERENCE TO RELATED APPLICATIONS

This application claims benefit of Provisional Application 60/322,633 filed Sep. 12, 2001.

### TECHNICAL FIELD

This invention relates to airplanes and in particular, to airplanes having a secure cockpit design.

### BACKGROUND

Airplane hijacking is a long standing problem and has been highlighted by the horrific events of Sep. 11, 2001 in the United States. In view of the severity and despicable destruction caused by a single plane hijacking, improved safety mechanisms and precautions are desired despite the infrequent nature of such events. Current methods to prevent plane hijackings include ground security cameras, baggage checks, questioning, surveillance and intelligence. Unfortunately, these techniques rely on human judgement, skill, and discipline. It has also been observed that airplane security can be distracted, rushed and fatigued depending on the hours worked and scheduling. For whatever reasons, hijackers have managed to board and commandeer various safeguarded planes including large commercial airliners.

Accordingly, a secure cockpit system is desirable to eliminate human error from airplane safety and prevent planes from being hijacked.

### SUMMARY OF THE INVENTION

The present invention includes a plane comprising a passenger chamber for transporting a plurality of passengers and a cockpit separated from the passenger chamber by an impenetrable barrier. The barrier may comprise bullet-proof glass, blast-resistant polymeric materials, or other high strength (preferably lightweight) materials. The cockpit may also comprise an exit or emergency hatch to the outside of the plane. Pressure relief panels, sensors, scanners and weapon devices may be incorporated into the plane to secure the cockpit. A method of transporting at least one passenger through the air on a plane flown by at least one pilot comprises impassably separating the at least one pilot from the at least one passenger.

### BRIEF DESCRIPTION OF THE DRAWINGS

FIG. 1 is an illustration of a plane in accordance with the present invention showing a barrier separating the cockpit from the passenger chamber.

FIGS. 2A and 2B are cross sections of the plane shown in FIG. 1 taken along A-A showing various cockpit security systems.

FIG. 3 is another cross section of the plane shown in FIG. 1 taken along A-A showing a cockpit security system having an openable door.

FIG. 4 is another cross section of the plane shown in FIG. 1 taken along A-A showing a cockpit security system having a door with a secure window.

FIGS. 5A and 5B are cross sections of the plane shown in FIG. 1 taken along A-A showing cockpit security systems having locking bars.

FIG. 6 is another cross section of the plane shown in FIG. 1 taken along A-A showing a cockpit security system having an openable door and a camera.

FIG. 7 is another cross section of the plane shown in FIG. 1 taken along A-A showing a cockpit security system having an openable door and a weapon or deterrent device.

FIG. 8 is another cross section of the plane shown in FIG. 1 taken along A-A showing a cockpit security system having a folding door and a seam.

### DETAILED DESCRIPTION

The present invention is directed to a plane having an improved cockpit structure. In particular, the plane of the present invention includes a cockpit separated from the passenger chamber by an impenetrable barrier. During flight, the pilots and passengers are prevented from physically interacting with one another. The present invention thus inhibits hijacking of the plane by one or more passengers. Notably, in one variation, the present invention can function without human input thus eliminating human error and judgment from hijack dangers.

It is contemplated that features and aspects of the following embodiments may be combined with one another unless such features are mutually exclusive. Indeed, the present invention may include a wide variety of features and combinations of features.

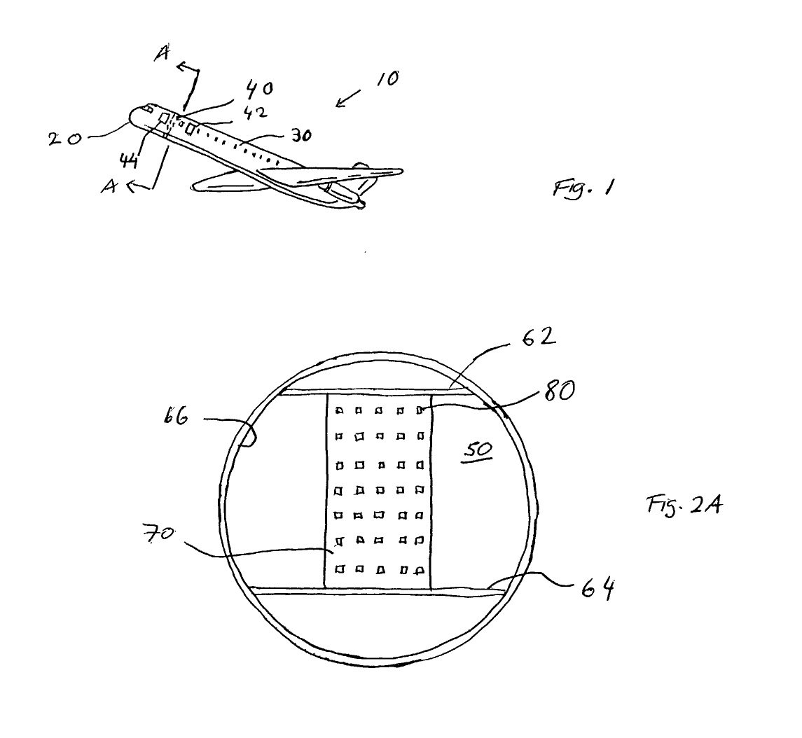

FIG. 1 depicts a plane 10 in accordance with the present invention. The plane 10 includes a cockpit 20 which typically houses the pilots and controls of the plane. The plane 10 also includes a passenger chamber or cabin 30 for sitting passengers. Some large commercial airliners, for example, sit at least 100 and upwards passengers. Except for the novel features disclosed in this application, the plane depicted in FIG. 1 can be similar to a jet airliner as is known in the field including, without limitation, BOEING 737's, 747's, 767's, MD-80's etc. See also, MARKS' STANDARD HANDBOOK FOR MECHANICAL ENGINEERS, 11-44 to 11-91 (9th ed.) (describing aeronautics and jet propulsion). Additionally, propeller planes and other air vehicles may be benefited by the present invention. Helicopters, trains, ships, space ships, shuttles, carriages, automobiles and other vehicles which are susceptible to being hijacked may be benefited by the present invention.

FIG. 1 also depicts a barrier 40 separating the cockpit from the passenger chamber. The barrier is preferably impenetrable, impassible, unopenable, doorless, rigid, unbreakable and/or unbendable. Suitable materials include metallic alloys, steels, high strength polymers and composites, KEVLAR, acrylic, or bullet proof glass or plastic. For example, titanium may be a suitable material. Also, the barrier may be an armored or coated frame, wall, or other structure. The armor may be, for example, a metal or composite material that increases the strength, blast-resistance, or ballistics-resistance properties of the structure. The barrier preferably weighs relatively little (e.g., 100-200 lbs or perhaps, 30 to 65 lbs) so that less lift force is required to fly the plane. The barrier may be integral with the frame of the plane. Conventional attachment techniques may be used to build the barrier in the plane. Welding, adhesives and/or fasteners may be suitable to mount the barrier to the deck, ceiling, fuselage, and or chassis of the plane. The barrier may range in thickness from, for example, 1 to 24 inches and perhaps from 3-10 inches. However, another thickness may be suitable.

When the aircraft has an unopenable barrier separating the cabin from the cockpit, and when the aircraft is used for long term trips, the cockpit may be constructed to include a bed, lavatory, food, drink and rest facilities. Also, a hatch 44 to the exterior of the plane may be included for the pilots to get on and off the plane. The hatch 44 may also be used as an emergency exit for the pilot.

The barrier or cockpit door may also include pressure relief membranes. The membranes may be discrete panels that break, blowout, or are frangible at certain pressures. For example, the membranes may be set to fail when the pressure difference between the cockpit and the cabin is greater than 2-10%, 11-30% or perhaps upwards of 30%. This may be useful in situations when the cabin loses pressure or decompresses rapidly. An example of a membrane may be a sheet of metal tested or certified to withstand a certain pressure before failure. Such a piece may conveniently be incorporated into a door or wall separating the cockpit from the cabin. The membrane or panel may be mounted in a window defined in the door or wall. The size and shape of the windows may vary greatly. For example, the window may be oval, square, rectangular, a slit, etc. Also, the window may be sized smaller than the waistline (or body) of an adult human or child such that an individual may not enter the cockpit via the window. However, in the event the cabin rapidly depressurizes, the size and number of windows should provide sufficient fluid communication (and flowrate of air) between the cabin and the cockpit to minimize hazardous effects which may arise from a rapid decompression of the cabin.

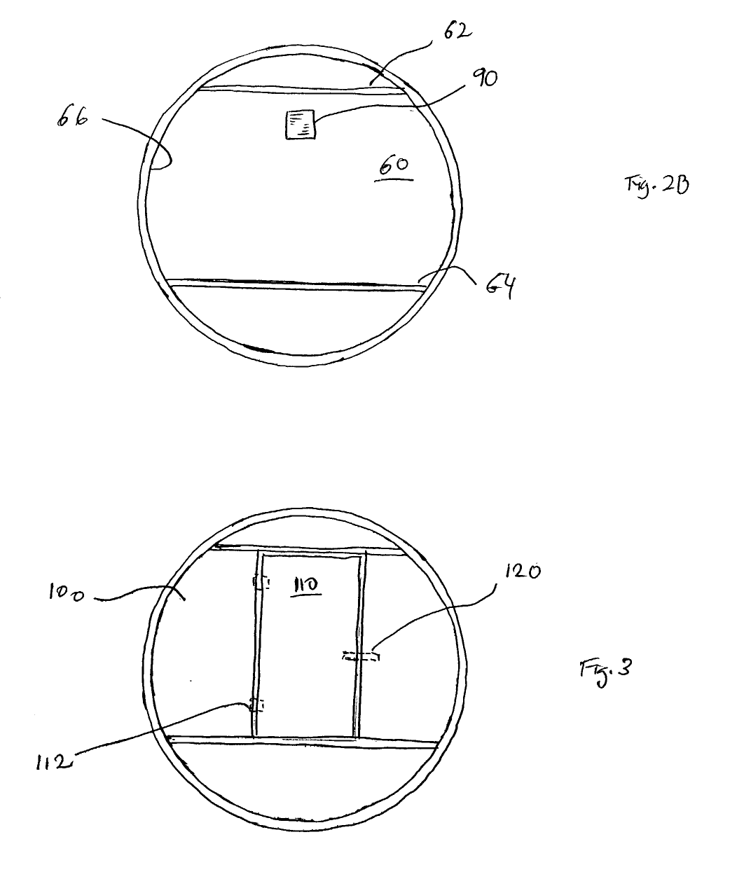

FIGS. 2A-2B show variations of the present invention including a barrier 50, 60 respectively. The barrier may be connected to the ceiling 62, deck 64, and the fuselage or body 66 of the plane. Metal or alloy mounting fasteners, bars, and brackets may be used to join the components together as is known to those of skill in the art. The barrier in FIG. 2A includes an open-member frame 70 which includes gaps 80. The gaps may be sized to allow small objects, light and acoustic waves to pass through. Suitable cross section areas for a gap ranges from 0.1 sq. in to 20 sq. in. and more preferably from 1 to 10 sq. in. and most preferably from about 2-8 sq. inches. The frame may be formed from an integral plate by creating holes in the plate. Also, the frame may be a simple metal or steel grill formed of metal bars or threads.

FIG. 2B also shows a barrier 60. Barrier 60 features a window 90 made of a transparent or partially transparent material such as plastic or glass. The window 90 is preferably strong and unbreakable as is the barrier support itself. Alternatively, a gap may be provided. The gap however should be small enough such that adults and children cannot pass through. A suitable material for the window is bullet-proof glass or plastic. The dimensions of the window may vary greatly. The dimensions of the gap however should, in this variation, be small as described above. The shapes of the window and gaps may be circular, square, rectangular or otherwise shaped. Again, as discussed above, a pressure relief membrane may be mounted in the window which bursts at a specific pressure. Such members are useful if a rapid decompression occurs in the cabin.

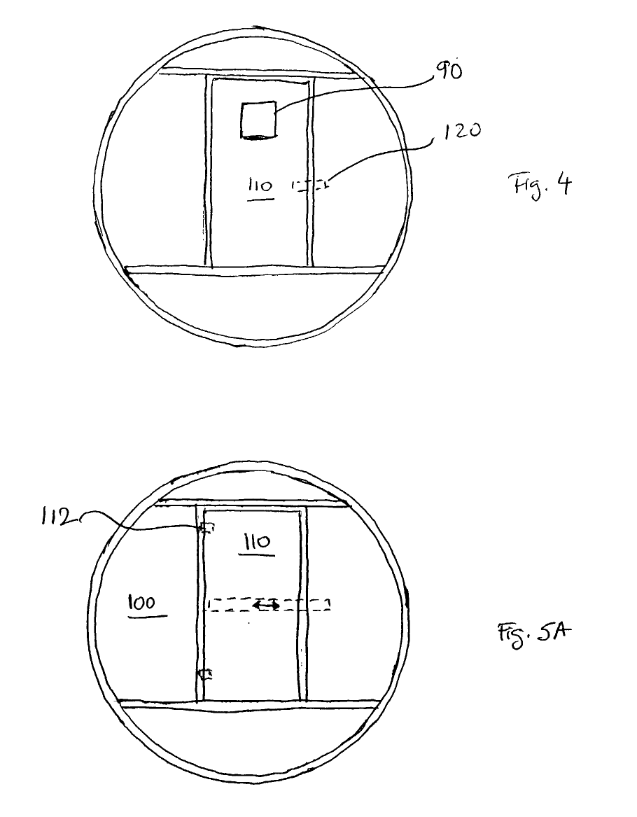

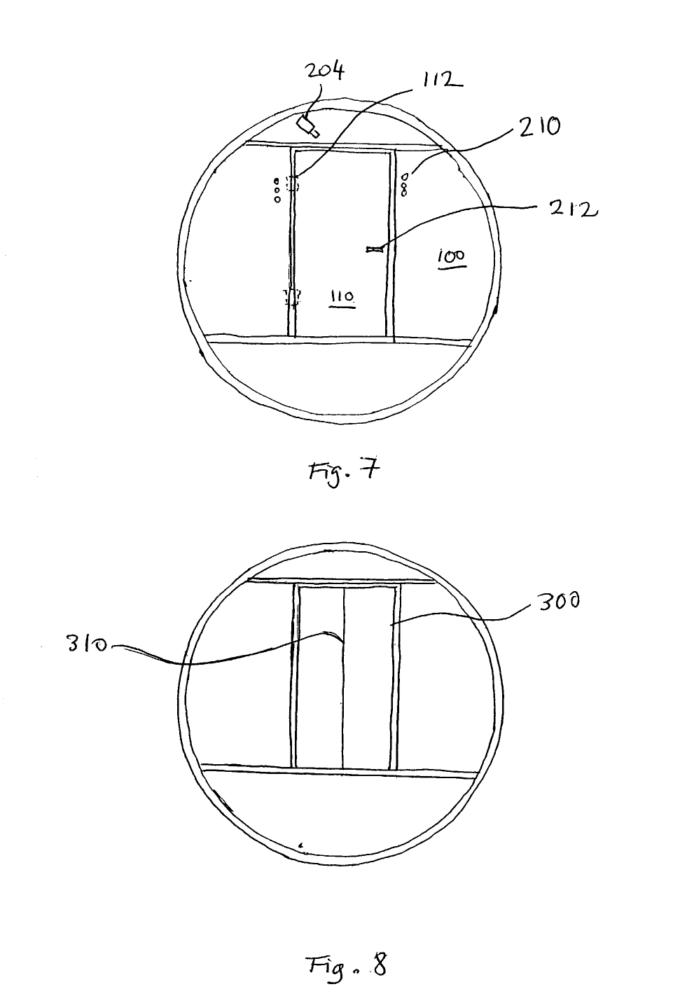

FIGS. 3-4 depict additional embodiments of the present invention. FIG. 3 illustrates a barrier 100 having an openable door 110. The door 110 may be rotatably secured to the barrier or wall 100 using, for example, hinges 112, perhaps steel hinges. Alternatively, the door may be a folding door hung on rails (or guides) which are secured to the ceiling, the deck, or both the ceiling and the deck of the aircraft. The door may have one or more seams or folds to minimize space. Two folds, three folds or perhaps more than three folds may be suitable for a folding door. A folding door 300 having one seam 310 is shown in FIG.8

The cockpit door 110 may also have a shatter proof window 90 as shown FIG. 4. The door 110 may be a heavy duty door and may be configured to be openable only remotely from the plane. That is to say, the door 110 may be constructed such that the pilots and passengers cannot open the door and only another person at a remote location can cause the door to be opened. However, the door may also be configured to be locked and unlocked by the pilot.

The lock 120 may be activated by an electromagnetic signal from a controller distal to the plane to open lock 120. Once opened, people may pass therethrough. Cameras and surveillance equipment may also be positioned to watch the passengers and pilots in the various chambers and cabins. Signals from the cameras may be sent to the remote location for determination of whether to open the door. The electromagnetic signal is preferably encrypted or coded so that accidental or copied signals cannot open the door.

The present invention may include a number of additional features to bolster security of the cockpit and pilots. It is typically desired to balance the need to allow the pilots to escape in an emergency versus the need for absolute cockpit security. Accordingly, the cockpit security system of the present invention, in some embodiments, may include an emergency switch (e.g., a button) or actuator to open the cockpit from inside the cockpit. The emergency switch may be located at a single point reachable by both pilots. The emergency switch may also be actuated from a remote location as discussed above. The actuating mechanism may be, for example, a solenoid controlled lock.

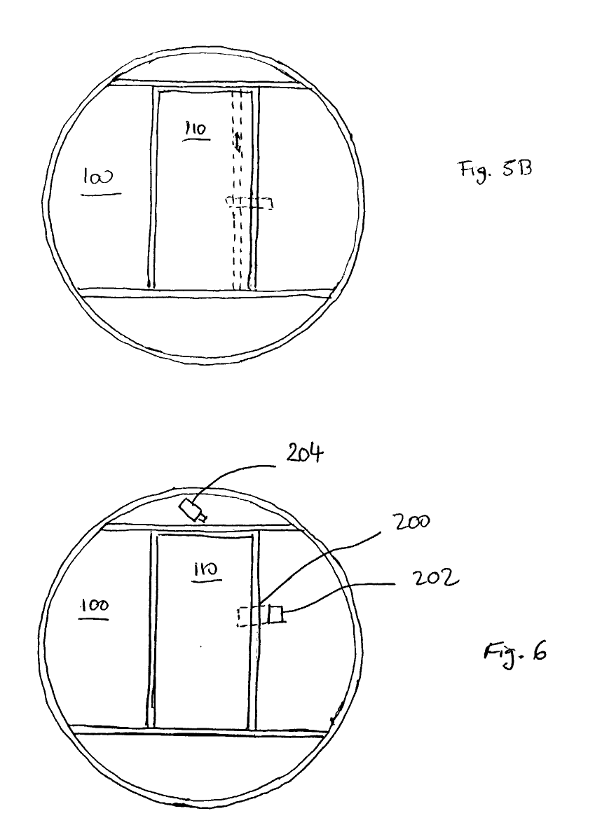

In another variation of the present invention, the cockpit door 110 may be secured with a lock bar. The lock bar may be movable relative to the wall 100 and door 110 in the horizontal or vertical directions as shown in FIGS. 5A and 5B respectively. These lock bars may be designed to extend across a portion of the door (or the entire door) and into a slot or opening in the wall such that the door cannot be opened. In particular, the lock bar may prevent the door from rotating about its hinges. If the door is a folding door, the lock bar or dead bolt can prevent the door from folding at its seam(s).

An example of a material for the lock bar is steel or titanium. However, other materials such as, without limitation, metals, high strength polymers, and composite materials may also be used.

Additionally, a lock bar may be pivotably mounted such that one end is free to rotate across the door and into a receiving slot opposite of the pivot point. When it desired to open the door, the end of the bar is rotated (or lifted) from the slot. Of course, the bar is preferably disposed on the inside of (or elsewhere within) the door so long as it is inaccessible to the passenger cabin and so long as it may be opened and locked from the inside of the cockpit or as otherwise described in this application. Such lock bar designs are advantageous in that they may be retrofitted onto an existing cockpit door or wall.

Another variation of the present invention is shown in FIG. 6. The cockpit door of FIG. 6 includes a locking mechanism 200 which may comprise, for example, a deadbolt (or solenoid lock, etc.) electronically controlled by a sensor or reader 202. The sensor or reader 202 may receive various information from a scan or input signal. The scan may be of a biological nature such as a retina or finger print scan. The device may be configured to interrogate DNA, hair, proteins, biological cells, biological fluids, or other biological materials that can identify a person. Once the person requesting entrance is properly identified, the cockpit door may be opened (automatically or via an additional screening or approval). Also, the reader may detect information from a card such as an identification card. The reader may comprise a keypad to receive a personal identification number (PIN). The reader may also be a microphone to receive and analyze voice data. The received information may be delivered electronically to a computer either on board or distal to the airplane to be interrogated or otherwise compared with information to confirm an identification or otherwise confirm that the door may be opened. A computer algorithm may be employed to compare the received information with information in a database to determine whether the door may be opened.

The reader may also be configured to open the door if and only if more than one person approves opening the door. The reader or computer algorithm may also be configured to require biological information from more than one person to approve opening the door. Again, the pilots, computer, and any other security personal may be given additional information from selectively positioned cameras 204. The cameras may be movable to scan, focus, zoom and otherwise track suspicious activity. Cameras or mechanisms which are tampered with or otherwise defective may trigger an automatic door lock signal preventing the door from being opened until safe landing.

FIG. 7 depicts yet another variation of the present invention having a cockpit door 110 hung in a frame of a wall 100. The system in this figure however additionally includes a weapon device 210 to inhibit, dehabilitate or kill an unauthorized person attempting to open the cockpit door 110. The weapon 210 may be a chemical or gas which is selected to cause extreme discomfort, sleep, tears, perhaps death, to people in the vicinity of the cockpit door on the cabin side. For example, a pepper spray or tear gas may be ejected or another more dehabilitating gas may be delivered into the cabin. Of course, care should be exercised so as to not harm the passengers more than necessary.

In extreme emergencies, and when it is determined a clear and present danger exists that the plane will be used as weapon of mass destruction intended to destroy an important structure such as the White House, a tower, a stadium, a bridge, or freeway, a poisonous gas may be delivered to the cabin by, for example, fluidly connecting the cabin air with a supply of the poisonous gas. The cockpit would contemporaneously be fluidly sealed from the cabin such that the cockpit environment would remain relatively unchanged and the pilots would be uneffected by the poisonous gas. Another approach to prevent a hijacked plane from being used as a missile is to include mechanism on the plane for 1.) destroying the plane; 2.) controlling the direction of the plane, or 3.) cutting propulsion of the plane. To destroy the plane an explosive device may be incorporated into a secured area inaccessible to the pilots and cabin members. The explosive device may be activated either remotely or by the pilots. For example, two card keys may be required to activate the explosive device. Likewise, the propulsion or jets may be shut off. Although the plane and people would likely be destroyed, the plane could not be used a missile to destroy another structure. A technique that would not kill the people on board is to provide an over-ride system which can override the pilot's controls. The over-ride system may be activated from a remote location on the ground using an electromagnetic signal. The electromagnetic signal would be received by a receiver on the plane that would trigger one or more outputs based on the particular input signal received. For example, the receiver could signal to a controller to cut the power supply to the cockpit or plane; cut the fuel supply to the jets; activate a bomb; deactivate the pilot controls; and/or connect the aircraft controls with another controller that is controlled by a signal from outside the plane. To reiterate, these secure cockpit systems serve to prevent the plane from being commandeered by an unauthorized individual. Additionally, controlling or destroying the plane using hardware installed on the plane itself may be more effective than launching missiles at the plane from ground or air-based defense systems.

In the event gas is used as the weapon, gas tanks may be fluidly connected with the ports 210. Other weapons such as bullets, laser, electric shock etc may also be used. Each of these weapons may be set in the cockpit door or wall and selectively aimed and activated by the pilots or an authorized person remote to the plane.

FIG. 7 also depicts a handle 212 which may be used to open the door when unlocked. The handle may be connected with a locking mechanism within the door and inaccessible or covered by the door material such that the lock is tamper resistant. Likewise, the hinges, floor ramp, ceiling rail, door jamb, and any additional components may be covered by material such that they may be accessed only from within the cockpit or from another location outside of the cabin. The handle or latch may be connected with an electric voltage supply to shock unauthorized persons attempting to enter the cockpit.

All publications, patent applications, patents, and other references mentioned herein are incorporated by reference in their entirety. To the extent there is a conflict in a meaning of a term, or otherwise, the present application will control.

All of the features disclosed in the specification (including any accompanying claims, abstract and drawings), and/or all of the steps of any method or process disclosed, may be combined in any combination, except combinations where at least some of such features and/or steps are mutually exclusive. Each feature disclosed, in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A plane comprising:
a passenger chamber for transporting a plurality of passengers; and
a cockpit separated from said passenger chamber by an impenetrable barrier.

2. The plane of claim 1 wherein the barrier comprises an open-member frame having a plurality of gaps.

3. The plane of claim 2 wherein at least one gap has an area in the range of 2-8 sq. in.

4. The plane of claim 2 wherein the barrier comprises one of a metal, an alloy, a metal alloy, a high strength polymer, and a composite material.

5. The plane of claim 2 wherein the frame comprises one of a metal, an alloy, a metal alloy, a high strength polymer, and a composite material.

6. The plane of claim 1 wherein the barrier comprises a transparent bullet-proof material.

7. The plane of claim 1 wherein the cockpit comprises a bathroom.

8. The plane of claim 7 wherein the cockpit comprises an exit hatch to the outside of the plane.

9. The plane of claim 1 wherein the barrier comprises at least one pressure relief panel.

10. A plane comprising:
a passenger chamber for transporting a plurality of passengers; and
a cockpit separated from said passenger chamber by a barrier, said barrier comprising a lockable, openable, bullet-proof door.

11. The plane of claim 10 wherein said door is configured to lock and unlock from inside the cockpit.

12. The plane of claim 10 further comprising an over-ride control system that, when activated, removes control from the pilots of the plane.

13. The plane of claim 10 wherein the door is unlockable using an electromagnetic signal transmitted from a controller distal to the plane.

14. The plane of claim 11 wherein said cockpit further comprises an emergency switch which is configured to, when activated, open the door instantaneously.

15. The plane of claim 14 wherein said switch is positioned within reach of all pilots within the cockpit when said pilots are in their normal flight positions.

16. The plane of claim 10 further comprising a weapon device adapted to deter a person from attempting to enter the cockpit.

17. The plane of claim 16 wherein the weapon device is a handle on the door, said handle being selectively connected to a high voltage source.

18. The plane of claim 16 wherein the weapon device is adapted to deliver a gas.

19. The plane of claim 10 wherein at least one of the barrier and the door comprises at least one sensing device selected from the group consisting of a scanner, keypad, and camera.

20. A method of transporting at least one passenger through the air on a plane having a cockpit and flown by at least one pilot, said method comprising the steps of:
impassably separating the at least one pilot from the at least one passenger such that said at least one passenger may not access said cockpit.

21. The method of claim 20 wherein said step of separating the pilot from the passenger comprises retrofitting an old cockpit door with a secure cockpit system, the secure cockpit system comprising a doorframe, a door which is mountable in said doorframe such that said door may be opened and closed, said system further comprising a lock member which is movable relative to the door such that when the door is mounted and the frame installed in a wall between the cockpit and the cabin, the door may not be opened or unlocked from the cabin.

22. The method of claim 21 wherein the lock member is a vertically disposed bar.

23. The method of claim 21 wherein the door has a plurality of seams.

24. The plane of claim 16 further comprising a shut-off device that is configured to, when activated, render the plane uncontrollable by the pilots and passengers on board.

25. The plane of claim 12 wherein the over-ride control system is activated from a location remote to the plane using an electromagnetic signal.
